(19) United States
(12) Patent Application Publication
(10) Pub. No.: US 2015/0325254 A1
(43) Pub. Date: Nov. 12, 2015

(54) METHOD AND APPARATUS FOR DISPLAYING SPEECH RECOGNITION INFORMATION

(71) Applicant: SAMSUNG ELECTRONICS CO., LTD., Suwon-si (KR)

(72) Inventors: Jun-woo LEE, Seoul (KR); Ji-bum MOON, Seoul (KR); Ha-yeon YOO, Seongnam-si (KR); Ji-yeon LEE, Seoul (KR)

(73) Assignee: SAMSUNG ELECTRONICS CO., LTD., Suwon-si (KR)

(21) Appl. No.: 14/699,424

(22) Filed: Apr. 29, 2015

(30) Foreign Application Priority Data
May 9, 2014 (KR) 10-2014-0055751

(51) Int. Cl. G10L 21/10; G10L 17/22; G10L 15/08

(52) U.S. Cl. CPC G10L 21/10; G10L 15/08; G10L 17/22

(57) ABSTRACT

A method and an apparatus for displaying speech recognition information are provided. The method includes acquiring at least one of speech recognition information based on speech recognized by performing speech recognition, and response information indicating a processing result of the speech recognition information, displaying a speech recognition history list including the acquired information, in a first window region, selecting at least one of the acquired information included in the speech recognition history list, and updating response information corresponding to the selected at least one piece of acquired information.

### CROSS-REFERENCE TO RELATED APPLICATION(S)

This application claims priority from Korean Patent Application No. 10-2014-0055751, filed on May 9, 2014, in the Korean Intellectual Property Office, the disclosure of which is incorporated herein in its entirety by reference.

### BACKGROUND

1. Field

Apparatuses and methods consistent with exemplary embodiments relate to a method and apparatus for displaying speech information recognized by performing speech recognition.

2. Description of Related Art

Recently, user interface (UI) elements have been used in televisions (TVs) so that a user may interact with the TVs. Various functions (software) to be performed by a TV may be provided through a UI element, and various UI elements may improve user accessibility of a TV. Accordingly, techniques which use various UIs to improve the usability of a TV are in demand.

In an existing speech recognition UI environment, a speech input of a user may be completed by displaying various objects as thumbnail images according to recognized speech information and selecting an object, in response to a user input. However, the display of images or text according to recognized speech information is merely a display for a simple information delivery and is not interactive. The result is that a UI cannot be effectively provided.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

Additional aspects will be set forth in part in the description which follows and, in part, will be apparent from the description, or may be learned by practice of the presented embodiments.

According to an aspect of an exemplary embodiment, there is provided a method of displaying speech recognition information, the method including acquiring at least one of speech recognition information based on speech recognized by performing speech recognition, and response information indicating a processing result of the speech recognition information; displaying a speech recognition history list including the acquired information, in a first window region; selecting at least one piece of the acquired information included in the speech recognition history list; and updating response information corresponding to the selected at least one piece of acquired information.

The updating the response information may include updating the response information based on a point in time at which the at least one piece of information is selected.

The response information may include suggested words for inducing a speech input of a user.

The at least one piece of information may be selected in response to a user input received by at least one of a motion input method, a touch input method, and a key input method.

In response to the speech recognition information including information about a question or request of the user, the response information corresponding to the speech recognition information may include at least one of information indicating whether the question or request of the user is able to be processed, information about a suggestion for the question or request of the user, and information about a processing result of the question or request of the user.

The method may further include displaying a user interface for performing an operation corresponding to the response information, in a second window region.

According to an aspect of another exemplary embodiment, there is provided a terminal apparatus including a controller configured to acquire at least one of speech recognition information including speech information recognized by performing speech recognition, and response information indicating a processing result of the speech recognition information, select at least one piece of the acquired information, and update response information corresponding to the selected information; and a display configured to display a speech recognition history list which includes the acquired information and the updated information, in a first window region.

The controller may be configured to update the response information corresponding to the selected at least one piece of information based on a point in time at which the at least one piece of information is selected.

The display may be configured to display response information including suggested words for inducing a speech input of a user.

The controller may be configured select the at least one piece of information, in response to a user input received by at least one of a motion input method, a touch input method, and a key input method.

In response to the speech recognition information including information about a question or request of the user, the response information corresponding to the speech recognition information may include at least one of information indicating whether the question or request of the user is able to be processed, information about a suggestion for the question or request of the user, and information about a processing result of the question or request of the user.

The display may be configured to display a user interface for performing an operation corresponding to the response information, in a second window region.

According to an aspect of another exemplary embodiment, there is provided a non-transitory computer-readable medium having recorded thereon a computer program that is executable by a computer to perform the methods described herein.

### BRIEF DESCRIPTION OF THE DRAWINGS

The above and/or other aspects will be more apparent by describing certain exemplary embodiments with reference to the accompanying drawings, in which:

FIG. 1 is a block diagram of a terminal apparatus according to an exemplary embodiment;

FIG. 2 is a block diagram of the terminal apparatus according to another exemplary embodiment;

FIG. 3 is a block diagram of a software configuration of the terminal apparatus according to an exemplary embodiment;

FIG. 4 illustrates speech recognition information according to an exemplary embodiment;

FIG. 5 is a flowchart of a method of displaying speech recognition information, according to an exemplary embodiment;

FIG. 6 is a flowchart of a method of displaying additional information and speech recognition information, according to an exemplary embodiment;

FIGS. 7 through 9 illustrate examples of displaying speech recognition information by processing one piece of speech recognition information selected from a speech recognition history list, according to exemplary embodiments;

FIG. 10 illustrates a method of displaying speech recognition information based on previously acquired speech recognition information, according to an exemplary embodiment;

FIG. 11 illustrates a method of displaying speech recognition information including a user interface for performing an operation, according to an exemplary embodiment; and

FIG. 12 illustrates a method of displaying speech recognition information including suggested words, according to an exemplary embodiment.

### DETAILED DESCRIPTION OF THE EXEMPLARY EMBODIMENTS

Hereinafter, exemplary embodiments are described in greater detail with reference to the accompanying drawings. However, in the following description, well-known functions or constructions may not be described in detail so as not to obscure the embodiments with unnecessary detail. In addition, like reference numerals denote like elements throughout the specification.

The terminology or words used in the specification and claims described below should not be analyzed as having a common or lexical meaning and should be analyzed as having a meaning and concept conforming to the technical spirit of the present disclosure under the principle that the inventor can best define the terminology for describing the disclosure. Therefore, the exemplary embodiments disclosed in the specification and the configurations shown in the drawings are merely exemplary embodiments do not entirely represent the technical spirit of the present disclosure. Thus, it should be understood that various equivalents and modifications for replacing the exemplary embodiments may exist at the filing date of the present application.

In the accompanying drawings, some components are exaggerated, omitted, or schematically shown, and sizes of components may not fully reflect actual sizes thereof. Also, the exemplary embodiments are not limited to the relative sizes or intervals shown in the accompanying drawings.

In the specification, when a certain part includes a certain component, this indicates that the part may further include another component instead of excluding another component unless there is a different disclosure. In addition, terms such as “unit” or “module,” disclosed in the specification indicates a unit for processing at least one function or operation, and may be implemented by hardware, software, or a combination thereof.

Hereinafter, exemplary embodiments are described with reference to the accompanying drawings so that those of ordinary skill in the art may easily comprehend the present disclosure. However, the exemplary embodiments may be embodied in many different forms and should not be construed as being limited to the exemplary embodiments set forth herein. In the drawings, parts irrelevant to the description may be omitted for clarity.

As used herein, the term “and/or” includes any and all combinations of one or more of the associated listed items. Also, expressions such as “at least one of,” when preceding a list of elements, modify the entire list of elements and do not modify the individual elements of the list.

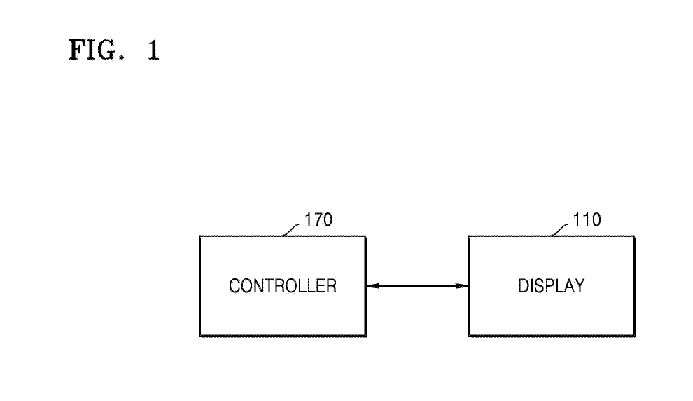

FIG. 1 is a block diagram of a terminal apparatus 100 according to an exemplary embodiment.

Referring to FIG. 1, the terminal apparatus 100 may display a speech recognition history list including speech recognition information, which includes speech information input by a user, and response information, which indicates a processing result of the speech recognition information. For example, the speech recognition history list may include at least one piece or item of speech recognition information and response information corresponding to the at least one piece or item of speech recognition information. The speech recognition information and the response information may be sorted in a predetermined order. For example, the speech recognition information and the response information may be sorted based on a point in time at which speech recognition corresponding to each piece of information is processed or a point in time at which each piece of information is generated.

As a non-limiting example, the terminal apparatus 100 may be or may be included in a terminal such as a television, a display, a phone, a game console, an appliance, a computer, a tablet, a kiosk, a monitor, a set-top box, and the like.

The speech recognition information may be obtained by recognizing user speech and may include information about a request from the user to request the terminal apparatus 100 or an external device (not shown) for a specific operation. When the user requests the external device for a specific operation, speech recognition information may be delivered to the external device to perform the operation, in response to the user request. In addition, response information may include a result of processing the speech recognition information, which includes speech input information of the user, by the terminal apparatus 100 or the external device. For example, the response information may include information indicating whether to enable a question or a request of the user to be processed, information about a suggestion for the question or the request of the user, and/or information about a processing result of the question or the request of the user.

In the examples below, for convenience of description, an operation according to speech recognition information is requested to and performed by the terminal apparatus 100.

In addition, response information corresponding to speech recognition information may include suggested words for inducing a speech input of the user. For example, the terminal apparatus 100 may determine additional information using currently input speech recognition information and acquire and display response information including a guideline, e.g., a question or suggested words. Therefore, according to one or more exemplary embodiments, the terminal apparatus 100 may easily perform a control operation based on speech recognition by displaying response information generated based on previous speech information of the user.

According to an exemplary embodiment, at least one piece of information may be selected from the speech recognition information and the response information, which are included in the speech recognition history list, according to an input signal. For example, a user may interact with speech recognition information and response information, thus enabling a user to more conveniently use speech recognition information and information processed by the apparatus based on the user speech. In addition, response information corresponding to the selected at least one piece of information may be updated and displayed. The user may request the terminal apparatus 100 to repeatedly process a previous operation and display a result thereof as response information by selecting the at least one piece of information.

According to an exemplary embodiment, at least one piece of information may be selected from the speech recognition information and the response information, which are included in the speech recognition history list. For example, the information may be selected by speech input or by an input method other than a speech input or without a particular speech input. For example, the user may select information from the speech recognition history list by a motion input, a touch input, a key input, or the like, or may select information by inputting through a speech input, a location of the information to be selected from the speech recognition history list. Therefore, the user may use a relatively simple or desired input method for selecting a previous speech input without the same speech input.

In the example of FIG. 1, the terminal apparatus 100 includes a controller 170 and a display 110.

The controller 170 may control a general operation of the display 110. For example, the controller 170 may acquire at least one piece of information selected from speech recognition information, which includes speech information recognized by performing speech recognition, and/or response information indicating a processing result of the speech recognition information. In addition, the controller 170 may control the display 110 to display a speech recognition history list, which includes the speech recognition information and the response information corresponding to the speech recognition information, in a first window region. The speech recognition history list may be displayed in a first window region of the display 110. In addition, when at least one piece of information is selected from the speech recognition information and the response information which are included in the speech recognition history list, the controller 170 may update response information corresponding to the selected at least one piece of information. The updated information may be displayed on the display 110.

The display 110 may display the speech recognition history list in the first window region under control of the controller 170. In addition, the display 110 may display a user interface for an operation according to the user input, together with the speech recognition history list. The user interface may include information about a result of the operation and/or information to be provided to the user. Also, the user interface may be used to perform the operation corresponding to the user input or the response information. For example, the display 110 may display the user interface in a second window region.

When at least one piece of information is selected from the speech recognition history list, the display 110 may display updated response information corresponding to the selected at least one piece of information. When the speech recognition information is selected, updated response information corresponding to the speech recognition information may be displayed. When the response information is selected, the selected response information may be updated and displayed. For example, the response information may be updated based on a point in time at which information is selected.

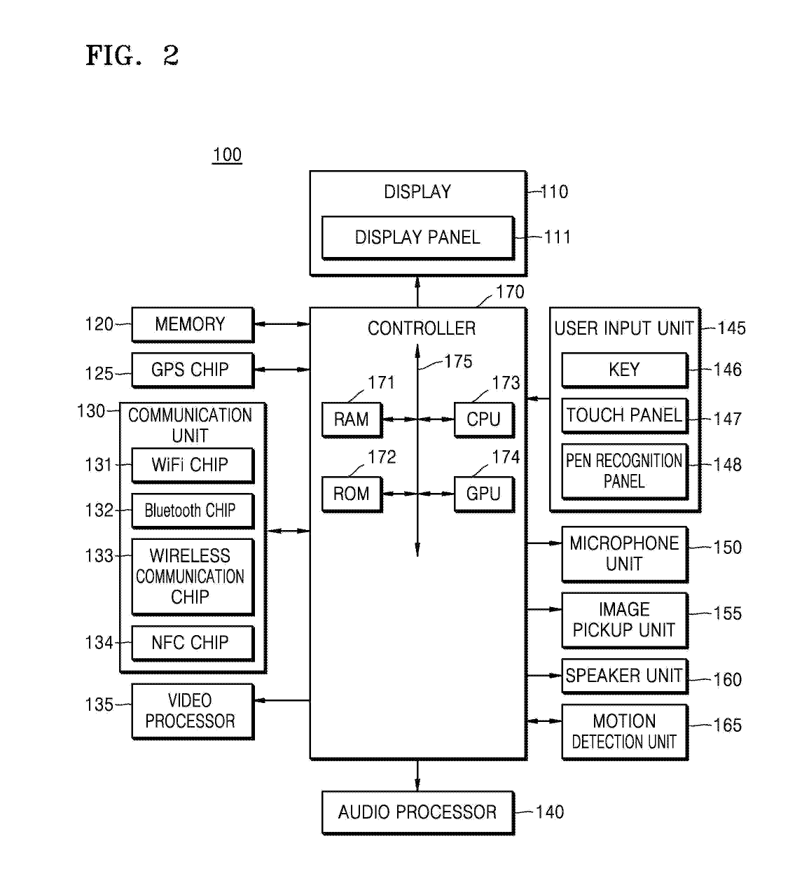

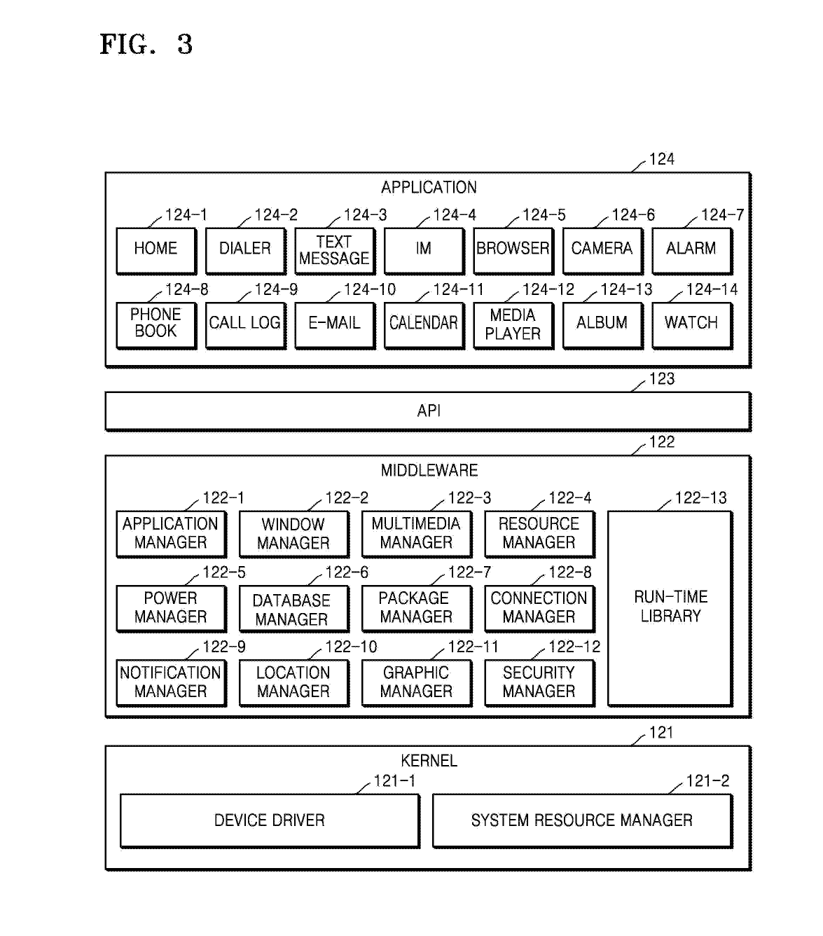

An example configuration of the terminal apparatus 100 is further described with reference to FIGS. 2 and 3.

FIG. 2 is a block diagram of the terminal apparatus 100 according to another exemplary embodiment.

As a non-limiting example, the terminal apparatus 100 shown in FIG. 2 may be applied to various types of devices, such as mobile phones, tablet PCs, personal digital assistants (PDAs), MP3 players, kiosks, electronic frames, navigation machines, digital TVs, smart TVs, wearable devices, such as wrist watches and head-mounted displays, and the like.

Referring to FIG. 2, the terminal apparatus 100 may include at least one of a display 110, a controller 170, a memory 120, a global positioning system (GPS) chip 125, a communication unit 130, a video processor 135, an audio processor 140, a user input unit 145, a microphone unit 150, an image pickup unit 155, a speaker unit 160, and a motion detection unit 165. The controller 170 and the display 110 in FIG. 2 may correspond to the controller 170 and the display 110 in FIG. 1, respectively.

According to FIG. 2, the display 110 may include a display panel 111 and a controller (not shown) for controlling the display panel 111. The display panel 111 may be implemented by various types of displays, for example, a liquid crystal display (LCD), an organic light-emitting diode (OLED) display, an active-matrix OLED (AM-OLED) display, a plasma display panel (PDP), and the like. The display panel 111 may be implemented such that it is flexible, transparent, and/or wearable. In some examples, the display 110 may be coupled to a touch panel 147 of the user input unit 145 and be provided as a touch screen. For example, the touch screen may include an integrated module in which the display 110 and the touch panel 147 are coupled in a stacked structure.

According to an exemplary embodiment, the display 110 may display a speech recognition history list in a first window region and may update and display response information corresponding to a selected one of a plurality of pieces of information.

The memory 120 may include an internal memory and/or an external memory (not shown). For example, the internal memory may include at least one of volatile memories (e.g., dynamic random access memory (DRAM), static RAM (SRAM), synchronous DRAM (SDRAM), and the like), nonvolatile memories (e.g., one time programmable read only memory (OTPROM), PROM, erasable and programmable ROM (EPROM), electrically EPROM (EEPROM), and the like), a hard disk drive (HDD), and a solid state drive (SSD). According to an exemplary embodiment, the controller 170 may load a command or data received from a nonvolatile memory or at least one of the other components to a volatile memory and process the loaded command or data. In addition, the controller 170 may store data received from another component or data generated in a nonvolatile memory.

The external memory may include at least one of, for example, a compact flash (CF) memory, a secure digital (SD) memory, a micro-SD memory, a mini-SD memory, an extreme digital (xD) memory, a memory stick, and the like.

The memory 120 may store therein various kinds of programs and data to be used for an operation of the terminal apparatus 100. For example, the memory 120 may store a program for performing speech recognition and various programs that are executable based on the speech recognition history list and speech recognition.

The controller 170 may control the display 110 to display the speech recognition history list stored in the memory 120. As an example, the controller 170 may display the speech recognition history list stored in the memory 120 on the display 110. In addition, when a user performs a gesture at a certain region of the display 110, e.g., the first window region in which the speech recognition history list is displayed, the controller 170 may perform a control operation corresponding to the user gesture. For example, when at least one piece of information is selected from the speech recognition history list according to the user gesture, the controller 170 may control the display 110 to update and display response information corresponding to the selected at least one piece of information.

The controller 170 may include at least one of a RAM 171, a ROM 172, a central processing unit (CPU) 173, a graphic processing unit (GPU) 174, and a bus 175. For example, the RAM 171, the ROM 172, the CPU 173, the GPU 174, and the like, may be connected to each other via the bus 175.

The CPU 173 accesses the memory 120 and boots the terminal apparatus 100 using an operating system (OS) that may be stored in the memory 120. In addition, the CPU 173 performs various operations using various programs, content, data, and the like, stored in the memory 120.

The ROM 172 stores therein a set of instructions for system booting and the like. For example, when power is supplied to the terminal apparatus 100 by input of a turn-on command, the CPU 173 may copy the OS stored in the memory 120 and boot the system by executing the OS, according to the instructions stored in the ROM 172. After the booting is completed, the CPU 173 copies various programs stored in the memory 120 to the RAM 171 and performs various operations by executing the programs that are copied to the RAM 171.

The GPU 174 displays a UI screen in a region of the display 110 when the terminal apparatus 100 is completely booted. For example, the GPU 174 may create a screen on which an electronic document including various objects is displayed. For example, the various objects may include content, icons, menus, and the like. The GPU 174 calculates attribute values, such as a coordinate value, a shape, a size, a color, and the like, of each of the objects to be displayed according to a layout of the screen. The GPU 174 may create screens that have various respective layouts including objects based on the calculated attribute values. The screens created by the GPU 174 may be provided to the display 110 and displayed in respective regions on the display 110.

The GPS chip 125 may calculate a location of the terminal apparatus 100 by receiving GPS signals from one or more GPS satellites. For example, the controller 170 may calculate a location of the user by using the GPS chip 125 when a navigation program is used or when a current location of the user is desired.

The communication unit 130 may communicate with various types of external devices based on various types of communication schemes. The communication unit 130 may include at least one of a WiFi chip 131, a Bluetooth chip 132, a wireless communication chip 133, and a near field communication (NFC) chip 134. The controller 170 may communicate with external devices using the communication unit 130.

The WiFi chip 131 and the Bluetooth chip 132 may perform communication by a WiFi scheme and a Bluetooth scheme, respectively. For example, when the WiFi chip 131 or the Bluetooth chip 132 is used, various kinds of information may be transmitted and received after connecting communication by first transmitting and receiving various kinds of connection information, such as a service set identifier (SSID), a session key, and the like. The wireless communication chip 133 indicates a chip for performing communication based on various communication standards, such as Institute of Electrical and Electronics Engineers (IEEE), Zigbee, 3^{rd} generation (3G), 3G partnership project (3GPP), long term evolution (LTE), and the like. The NFC chip 134 indicates a chip that operates in an NFC scheme using a 13.56 MHz band from among various radio frequency identification (RF-ID) frequency bands, such as 135 kHz, 13.56 MHz, 433 MHz, 860˜960 MHz, 2.45 GHz, and the like.

The video processor 135 may process video data included in content that is received through the communication unit 130 or content that is stored in the memory 120. The video processor 135 may perform various kinds of image processing on the video data, such as decoding, scaling, noise filtering, frame rate conversion, resolution conversion, and the like.

The audio processor 140 may process audio data included in content that is received through the communication unit 130 or content that is stored in the memory 120. The audio processor 140 may perform various kinds of processing on the audio data, such as decoding amplification, noise filtering, and the like.

When a play program of multimedia content is executed, the controller 170 may control the video processor 135 and the audio processor 140 to play the corresponding content. The speaker unit 160 may output audio data that is generated by the audio processor 140.

The user input unit 145 may receive, as inputs, various instructions from the user. For example, the user input unit 145 may include at least one of a key 146, the touch panel 147, and a pen recognition panel 148.

The key 146 may include various types of keys such as a mechanic button, a wheel, and the like, formed in various regions, such as on a front part, a side part, a rear part, and the like, of the exterior of a main body of the terminal apparatus 100.

The touch panel 147 may detect a touch input of the user and output a touch event value corresponding to a detected touch signal. As an example, when the touch panel 147 is coupled to the display panel 111 to form a touch screen, the touch screen may be implemented by various types of touch sensors, such as a capacitive type, a resistive type, a piezoelectric type, and the like. The capacitive type may calculate touch coordinates by sensing minute electricity caused by a body of the user when a portion of the body of the user touches the surface of the touch screen. The resistive type may calculate touch coordinates by sensing a current flowing through upper and lower plates contacting each other at a touched point when the user touches the touch screen in which two electrode plates are embedded. A touch event may be generated on the touch screen may by a finger of a human or may be generated by an object of a conductive material that is capable of causing a change in capacitance.

The pen recognition panel 148 may detect a proximity input or a touch input of a pen according to an operation of a touch pen such as a stylus pen or a digitizer pen manipulated by the user and output a detected pen proximity event or a detected pen touch event. The pen recognition panel 148 may be implemented, for example, by an electromagnetic radiation (EMR) scheme and may detect a touch or proximity input depending on a change in the intensity of an electromagnetic field caused by an approach or touch of the touch pen. For example, the pen recognition panel 148 may include an electronic induction coil sensor having a grid structure and an electronic signal processing unit for sequentially providing an alternating current (AC) signal having a predetermined frequency to each loop coil of the electronic induction coil sensor. When a pen equipped with a resonance circuit is located nearby a loop coil of the pen recognition panel 148, a magnetic field generated by the loop coil may induce a current based on mutual electronic induction to the resonance circuit in the pen. An induction magnetic field may be generated by a coil forming the resonance circuit in the pen, and the pen recognition panel 148 may detect the induction magnetic field through a loop coil in a signal reception state, thereby detecting a proximity location or a touch location of the pen. The pen recognition panel 148 may include an area capable of covering a display area of the display panel 111.

The microphone unit 150 may receive speech of the user or other sounds and convert the received speech or sounds to audio data. The controller 170 may use speech which is input through the microphone unit 150 for a speech recognition operation or may convert the user speech to audio data and store the converted audio data in the memory 120.

The image pickup unit 155 may pick up a still image or a video image under control of the user. The image pickup unit 155 may be plural in number, such as a front camera and a rear camera.

When the apparatus 100 includes the image pickup unit 155 and the microphone unit 150, the controller 170 may perform a control operation depending on user speech that is input through the microphone unit 150 or a user motion that is recognized by the image pickup unit 155. For example, the terminal apparatus 100 may operate in a motion control mode or a speech control mode. In the motion control mode, the controller 170 may perform a control operation corresponding to a motion of the user by enabling the image pickup unit 155 to capture one or more images of the user and track a change in the motion of the user. In the speech control mode, the controller 170 may operate in a speech recognition mode in which user speech input through the microphone unit 150 is analyzed and a control operation is performed based on the analyzed user speech.

According to an exemplary embodiment, a speech recognition history list may be displayed on the display 110 by performing speech recognition in response to user speech. In this example, at least one piece of information included in the speech recognition history list may be selected by a motion input, a key input, a touch input, a user speech input, and the like.

The motion detection unit 165 may detect a motion of the main body of the terminal apparatus 100. For example, the terminal apparatus 100 may be rotated, tilted, or otherwise moved in various directions. In this case, the motion detection unit 165 may detect motion characteristics, such as a rotation direction, an angle, a gradient, and the like, of the terminal apparatus 100, by using at least one of various sensors, such as a geomagnetism sensor, a gyro sensor, an acceleration sensor, and the like.

Although not shown in FIG. 2, according to an exemplary embodiment, the terminal apparatus 100 may further include a universal serial bus (USB) port to which a USB connector may be connected, various external input ports for connecting to various external terminals such as a headset terminal, a mouse terminal, a local area network (LAN) terminal, and the like, a digital multimedia broadcasting (DMB) chip for receiving and processing a DMB signal, various sensors, and the like.

Examples of the above-described components of the terminal apparatus 100 may vary. In addition, the terminal apparatus 100 according to one or more exemplary embodiments may be formed with at least one of the above-described components, without one or more of the above-described components, and/or further include other additional components not described.

FIG. 3 is a block diagram of a software configuration of the terminal apparatus 100 according to an exemplary embodiment.

Referring to FIG. 3, the memory 120 may store the software of the terminal apparatus 100 such as the OS for controlling resources of the terminal apparatus 100 and application programs for operation of an application 124. As a non-limiting example, the OS may include a kernel 121, middleware 122, an application programming interface (API) 123, and the like, as shown. The OS may be, for example, Android, iOS, Windows, Symbian, Tizen, Bada, and the like.

The kernel 121 may include a device driver 121-1 and/or a system resource manager 121-2 that is capable of managing resources. The device driver 121-1 may permit various hardware of the terminal apparatus 100 to be controlled by accessing the hardware in a software manner. For example, the device driver 121-1 may include interfaces and individual driver modules provided by hardware manufacturers. The device driver 121-1 may include at least one of, for example, a display driver, a camera driver, a Bluetooth driver, a shared memory driver, a USB driver, a keypad driver, a WiFi driver, an audio driver, and an inter-process communication (IPC) driver. The system resource manager 121-2 may include at least one of a process management unit, a memory management unit, and a file system management unit. The system resource manager 121-2 may perform functions such as control, allocation, withdrawal, and the like, of system resources.

The middleware 122 may include a plurality of modules previously implemented to provide functions that are requested by various applications. The middleware 122 may provide the functions via the API 123 so that the application 124 efficiently uses resources of the terminal apparatus 100. The middleware 122 may include at least one of a plurality of modules. In this example, the middleware 122 includes an application manager 122-1, a window manager 122-2, a multimedia manager 122-3, a resource manager 122-4, a power manager 122-5, a database manager 122-6, a package manager 122-7, a connection manager 122-8, a notification manager 122-9, a location manager 122-10, a graphic manager 122-11, and a security manager 122-12, however, the middleware 122 is not limited thereto.

The application manager 122-1 may manage a life cycle of at least one application 124. The window manager 122-2 may manage GUI resources that are used on a screen of the terminal apparatus 100 or of another device that is connected to the terminal apparatus 100. The multimedia manager 122-3 may perceive formats for playing various media files and encode or decode a media file using a codec corresponding to a respective media file format. The resource manager 122-4 may manage resources of source codes of at least one application 124, a memory or storage space, and the like. The power manager 122-5 may manage a battery or other power source and provide power information and the like for an operation by cooperating with a basic input/output system (BIOS) and the like. The database manager 122-6 may manage the generation, search, and/or update of a database to be used by at least one application in the application 124.

The package manager 122-7 may manage installation and update of an application distributed in a format of a package file. The connection manager 122-8 may manage a wireless connection such as a WiFi or Bluetooth connection. The notification manager 122-9 may display or notify of an event, such as an incoming message, an appointment, proximity notification, and the like, in a manner which does not obstruct the user. The location manager 122-10 may manage location information of the terminal apparatus 100. The graphic manager 122-11 may manage a graphic effect that is provided to the user and to a relevant UI. The security manager 122-12 may provide a system security function and general security functions required for user authentication and the like. When the terminal apparatus 100 includes a telephone function, the middleware 122 may further include a phone call manager (not shown) for managing a voice or video call function.

As another example, the middleware 122 may further include a run-time library 122-13, and other library modules (not shown). The run-time library 122-13 may be used by a compiler to add functions through a programming language while an application is being executed. For example, the run-time library 122-13 may perform a function of input/output, memory management, an arithmetic function, and the like. The middleware 122 may create and use a new middleware module by combining the above-described various functions of the internal component modules. For example, the middleware 122 may provide a module for each OS in order to provide a differentiated function. The middleware 122 may dynamically delete some of the existing components and/or add new components. It should also be appreciated that some of the components in the present example may be omitted, other components may be further provided, and/or differently named components for performing similar functions may replace corresponding components in the middleware 122.

The API 123 may include a set of API programming functions and may be provided as a configuration depending on each OS. As a non-limiting example, for an Android or iOS operating system, a single API set may be provided for each platform. As another example, for a Tizen operating system, two or more API sets may be provided.

The application 124 may include a preload application that is installed as a default and/or third party application which may be installed and used during an operation of the user. The application 124 may include at least one of, for example, a home application 124-1 for returning to a home screen, a dialer application 124-2 capable of performing a telephone call, a text message application 124-3 for receiving a message from another based on a telephone number, an instant message (IM) application 124-4, a browser application 124-5, a camera application 124-6, an alarm application 124-7, a phone-book application 124-8 for managing a telephone number or an address of another, a call log application 124-9 for managing a call log of the user, an outgoing/incoming log of text messages, a missed call log, and the like, an e-mail application 124-10 for receiving a message from another that is identified based on an e-mail, a calendar application 124-11, a media player application 124-12, an album application 124-13, and a watch application 124-14.

Examples of the above-described components of the software may vary. In addition, the software according to the present exemplary embodiment may be formed with at least one of the above-described components, without one or more of the above-described components, and/or further include other additional components not described.

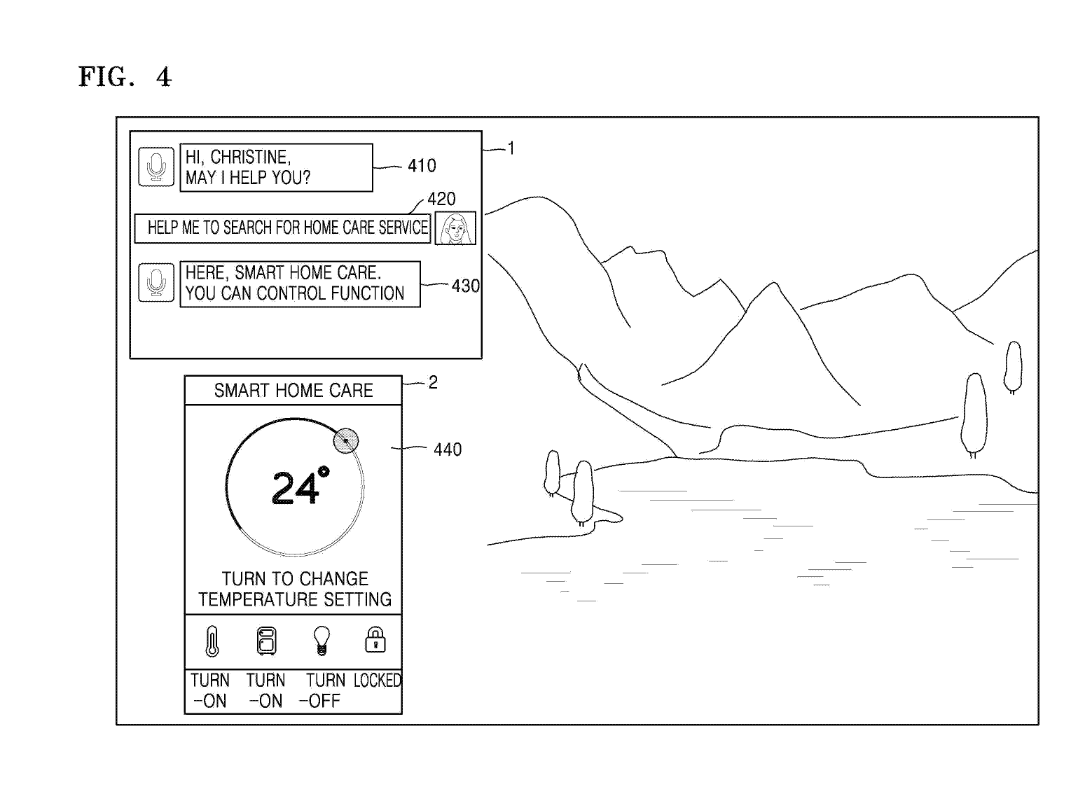

FIG. 4 illustrates speech recognition information according to an exemplary embodiment.

Referring to FIG. 4, speech recognition information 420 and response information 410 and 430 corresponding to respective speech recognition information, are included in a speech recognition history list, and are displayed in a first window region 1 in which the speech recognition history list is displayed. For example, the speech recognition history list may be displayed in the first window region 1 on one side of the display 120, and user interface 440 corresponding to the response information 430 may be displayed in a second window region 2, which in this example is located on the screen below the speech recognition history list.

The speech recognition history list may include speech recognition information sorted in an order in which speech recognition occurs and response information corresponding to the speech recognition information. A user interface corresponding to response information may include information for displaying a processing result of a user input based on speech recognition information. For example, the user interface may include information for displaying an application execution screen according to a user input. The user interface may include an interface for performing an operation according to the user input. In some examples, the first window region 1 and the second window region 2 in which the speech recognition history list and the user interface 440 may be respectively displayed may be translucent to enable a content play screen or an application execution screen to be displayed in the other region of the terminal apparatus 100.

In the first window region 1, the speech recognition history list may be displayed in a message conversion format between a speech recognition system and the user. The speech recognition information 420 indicating information obtained by recognizing user speech may be displayed as text as shown in FIG. 4, but is not limited thereto. As another example, the speech recognition information 420 may be displayed as an image or a thumbnail indicating the speech recognition information 420. The response information 430 indicating a processing result of the speech recognition information 420 may include information about a processing result, a suggestion, or a question about the speech recognition information 420. The response information 430 may include a response result of a speech recognition system, which corresponds to the speech recognition information 420.

In the second window region 2, the user interface 440 corresponding to the response information 430 may be displayed. The user interface 440 may include additional information indicating the processing result of the speech recognition information 420. For example, the user interface 440 may include an interface for an application to be executed according to a speech recognition result, content information to be provided to the user according to speech input information, and the like. The terminal apparatus 100 may also display an execution-requested application or content in the second window region 2. The application displayed in the second window region 2 may be executed in response to a user input. It should also be appreciated that a plurality of second window regions 2 may exist and be displayed on the terminal apparatus 100 according to response information, and content or application execution screens may be displayed in the plurality of second window regions 2.

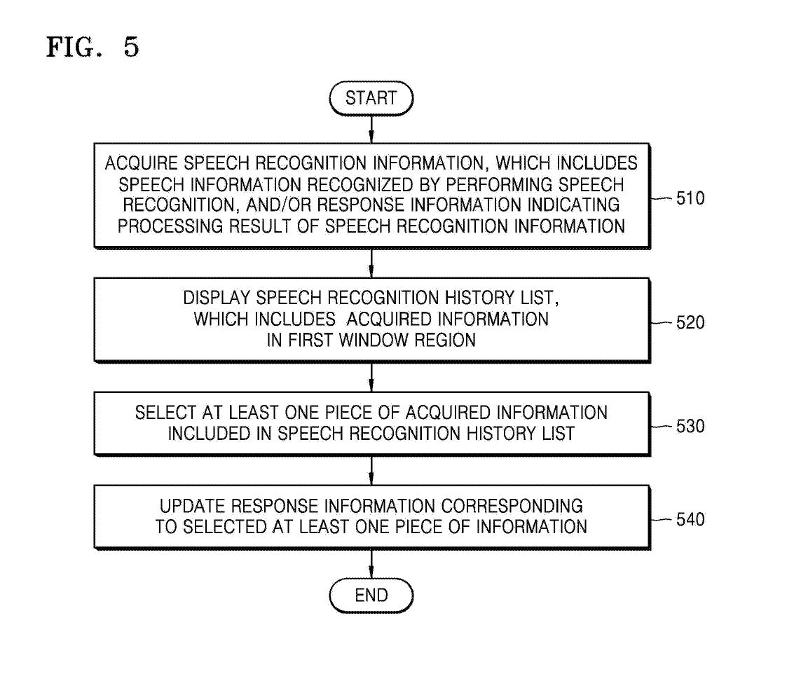

FIG. 5 is a flowchart of a method of displaying speech recognition information, according to an exemplary embodiment.

Referring to FIG. 5, in operation 510, the terminal apparatus 100 acquires speech recognition information, which includes speech information recognized by performing speech recognition, and/or response information indicating a processing result of the speech recognition information. For example, the terminal apparatus 100 may receive speech recognition information and/or response information from an external device or the speech recognition information and/or the response information acquired by performing speech recognition at the terminal apparatus 100. That is, the terminal apparatus 100 may acquire speech recognition information and response information by receiving speech recognition information and/or response information from the outside or by performing speech recognition in the terminal apparatus 100.

In operation 520, the terminal apparatus 100 displays a speech recognition history list, which includes the speech recognition information and the response information corresponding to the speech recognition information which are acquired in operation 510, in a first window region. For example, the speech recognition history list may include speech recognition information and response information which are sorted in an order of occurrence indicating message conversions between the user and the speech recognition system. The speech recognition information and the response information may be displayed as a text, but are not limited thereto. For example, the speech recognition information and the response information may be displayed in various ways for indicating the meaning of the speech recognition information and the response information using images, icons, symbols, and the like.

The speech recognition history list may be displayed in a partial region of the terminal apparatus 100, and when a content play screen or an application execution screen is displayed over the entire screen, the speech recognition history list may be translucently displayed to also enable the content play screen or the application execution screen to be viewed together with the speech recognition history list.

In operation 530, the terminal apparatus 100 selects at least one piece of acquired information included in the speech recognition history list. In operation 540, the terminal apparatus 100 updates response information corresponding to the selected at least one piece of information and displays the updated response information in the first window region. For example, the user may check previously performed speech recognition information and a processing result of the previously performed speech recognition information from the speech recognition history list. Accordingly, the user may select speech recognition information or response information related to an operation to be performed again by the user.

The terminal apparatus 100 may add the updated response information corresponding to the selected at least one piece of information to the speech recognition history list and display the speech recognition history list including the updated response information in the first window region. For example, the terminal apparatus 100 may acquire the updated response information by again performing an operation desired by the user and may display the updated response information in the first window region.

In the selecting of at least one piece of information from the speech recognition history list, the user may select the at least one piece of information by an input means other than through speech recognition by using a speech recognition history list displayed on a display. For example, the user may request to repeat an operation that was previously performed depending on speech recognition by selecting information included in the speech recognition history list using a motion input, a key input, a touch input, and the like, and thus, the user may input information via a relatively convenient method according to circumstances.

When a piece of the speech recognition information is selected from the speech recognition history list in operation 530, response information corresponding to the selected piece of the speech recognition information may be updated. Accordingly, the updated response information may be displayed in the first window region in which the speech recognition history list is displayed.

Also, when a piece of the response information is selected from the speech recognition history list in operation 530, response information obtained by updating the selected piece of the response information may be added to the speech recognition history list and displayed in the first window region. For example, the updated response information may include a result of performing an operation corresponding to selected information again based on a point in time at which information included in the speech recognition history list was selected or a point in time at which an operation for generating response information in response to selection of each information was performed.

For example, when speech recognition information requests the terminal apparatus to execute an application for a social network service (SNS) message transmission, the terminal apparatus 100 may determine whether SNS message transmission through a current application is available and display a result of the determination as response information. If the application for SNS message transmission cannot be executed, for example, because a network is disconnected or a corresponding application is not installed, the terminal apparatus 100 may display response information indicating that SNS message transmission is not available. In addition, the terminal apparatus 100 may also display a reason why the SNS message transmission is not available.

If speech recognition information including an application execution request for SNS message transmission and/or response information corresponding to the speech recognition information is selected while SNS message transmission is available, the terminal apparatus 100 may check again whether SNS message transmission through a current application is available. If it is determined that SNS message transmission is available, the terminal apparatus 100 may display response information indicating that the application for SNS message transmission is being executed. For example, the terminal apparatus 100 may display an application execution screen for the SNS message transmission in a second window region.

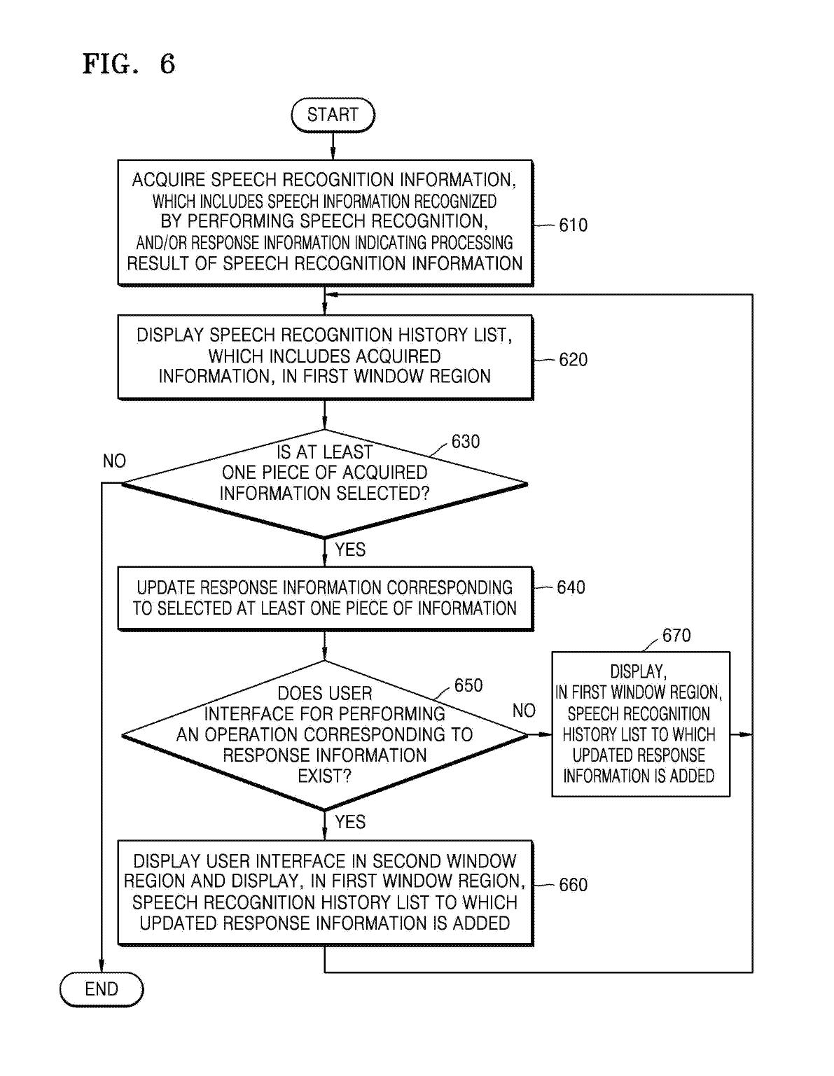

An example of a method of displaying speech recognition information with a user interface corresponding to response information is described with reference to FIG. 6.

FIG. 6 is a flowchart of a method of displaying a user interface corresponding to response information and speech recognition information, according to an exemplary embodiment. Operations 610 and 620 of FIG. 6 correspond to operations 510 and 520 of FIG. 5, respectively. Accordingly, repetitive descriptions may be omitted for convenience of the reader.

Referring to FIG. 6, in operation 610, the terminal apparatus 100 acquires speech recognition information, which includes speech information recognized by performing speech recognition and/or response information indicating a processing result of the speech recognition information.

In operation 620, the terminal apparatus 100 displays a speech recognition history list, which includes the speech recognition information and the response information corresponding to the speech recognition information which are acquired in operation 610, in a first window region.

In operation 630, the terminal apparatus 100 determines whether at least one piece of information from the speech recognition information and/or the response information included in the speech recognition history list is selected.

In response to at least one piece of information from the speech recognition history list being selected, the terminal apparatus 100 updates response information corresponding to the selected at least one piece of information in operation 640. For example, the terminal apparatus 100 may acquire updated response information by performing a previous operation again, in response to recognized speech content of the selected at least one piece of information.

In operation 650, the terminal apparatus 100 determines whether a user interface exists for performing an operation corresponding to the response information updated in operation 640. If the user interface exists, the terminal apparatus 100 displays the user interface and/or the updated response information in operation 660. The user interface may be displayed in a second window region, and the updated response information may be added to the speech recognition history list and displayed in the first window region.

However, if it is determined that the user interface corresponding to the updated response information does not exist in operation 650, the terminal apparatus 100 displays the updated response information in the first window region by adding the updated response information to the speech recognition history list in operation 670.

Thereafter, the terminal apparatus 100 may acquire speech recognition information obtained by performing speech recognition and/or response information, and display the acquired speech recognition information and/or response information in the first window region.

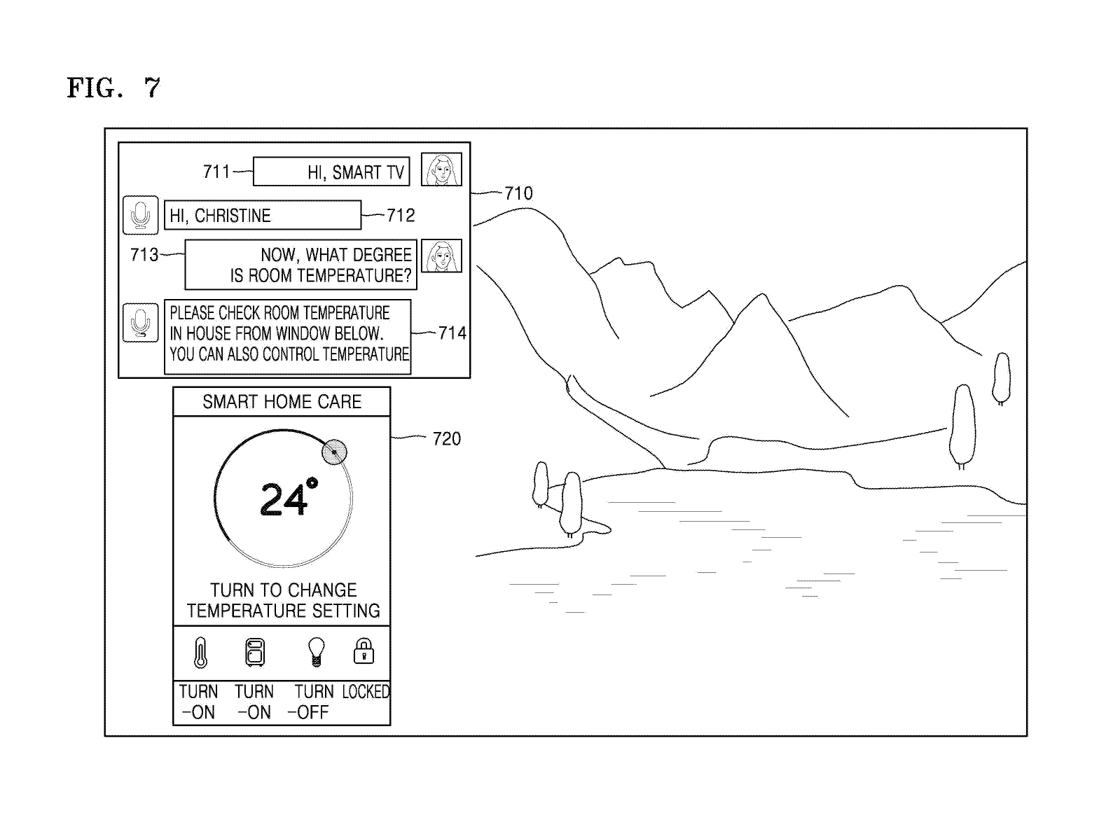

FIGS. 7 through 9 illustrate examples of displaying speech recognition information by processing selected piece of information, according to exemplary embodiments.

Referring to FIG. 7, a speech recognition history list and a user interface are displayed in a first window region 710 and a second window region 720, respectively.

Referring to the first window region 710, recognized speech information of the user is displayed as speech recognition information 711 and 713, and response information 712 and 714 corresponding to the recognized speech information of the user is also displayed. The terminal apparatus 100 may generate and display the response information 714 in response to the speech input (speech recognition information) 713 of the user and may additionally display the user interface in the second window region 720 in order to process a request of the user. For example, the user interface may be generated and displayed at the same time as the response information 714.

In an example in which the speech recognition information 713 of the user requests to know a room temperature, the terminal apparatus 100 may determine whether to process the user request. In response, the terminal apparatus 100 may display the user interface including an application execution screen for processing the user request, and the response information 714, in the second window region 720 and the first window region 710, respectively, according to a result of the determination.

The user may further perform another operation using a user interface including the application execution screen displayed in the second window region 720. For example, the user may control a temperature control application by inputting a command through various methods, such as a touch input method, a key input method, a motion input method, and the like, in the second window region 720.

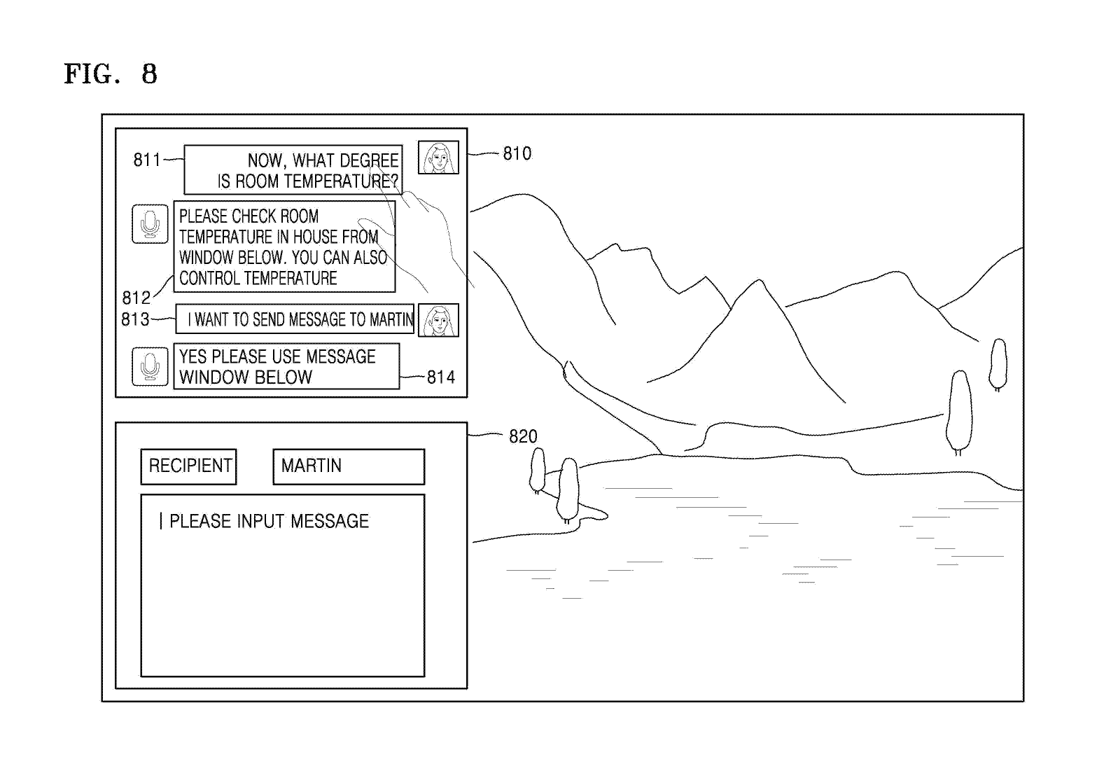

Referring to FIG. 8, a speech recognition history list and a user interface are displayed in a first window region 810 and a second window region 820, respectively, as in FIG. 7.

In the example of FIG. 8, speech recognition information 811 and response information 812 correspond to the speech recognition information 713 and the response information 714 in FIG. 7, respectively. Also, speech recognition information 813 and response information 814 are acquired thereafter and added to the speech recognition history list. Accordingly, the speech recognition information 811 and the response information 812 may be scrolled upwards and/or downwards and be displayed.

In response to the speech recognition information 813 of the user requesting to execute an application for sending a message, the response information 814 and a user interface, which includes a message application execution screen, may be displayed in the first window region 810 and the second window region 820, respectively.

In this example, if the user selects the speech recognition information 811 displayed in the first window region 810, response information and/or a user interface corresponding to the selected speech recognition information 811 may be displayed. For example, the response information and the user interface may include information updated by selecting the speech recognition information 811.

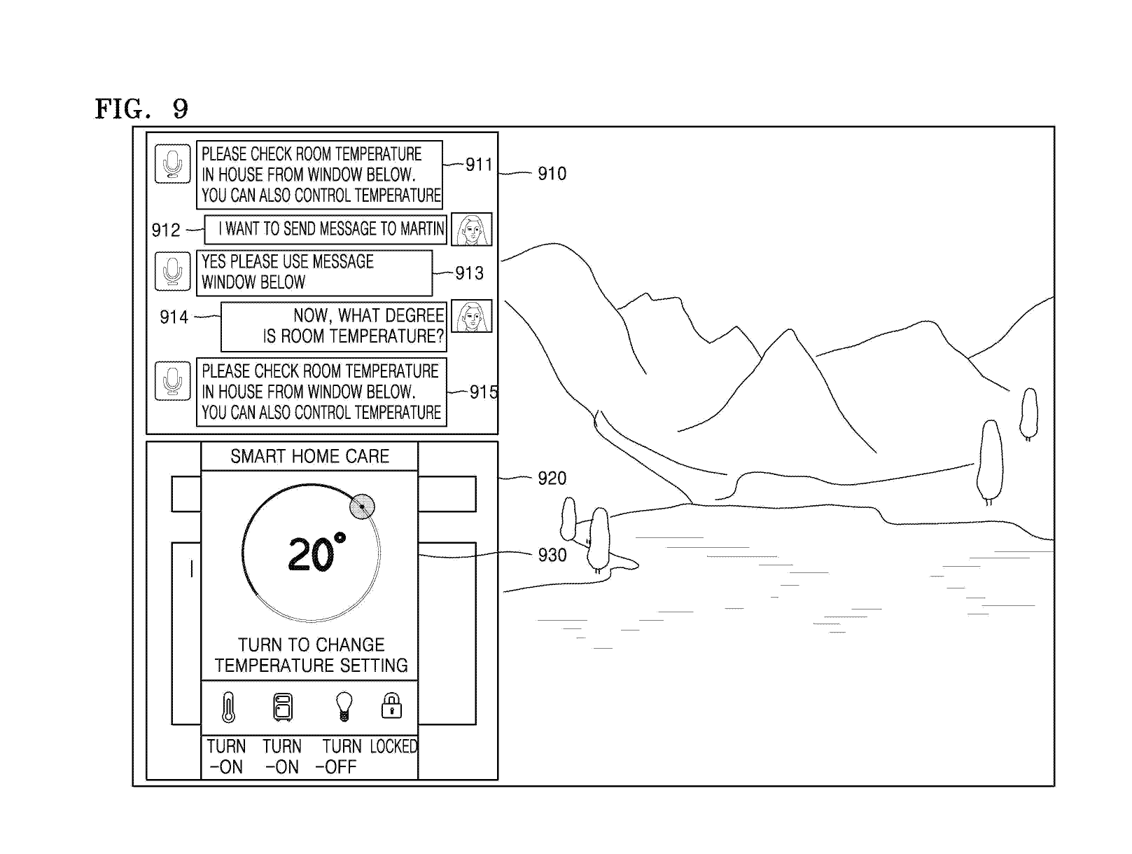

An example in which the speech recognition information 811 included in the speech recognition history list is selected is described with reference to FIG. 9.

Referring to FIG. 9, a speech recognition history list and a user interface are displayed in a first window region 910 and second window regions 920 and 930, respectively.

Speech recognition information 912 and response information 913 in FIG. 9 correspond to the speech recognition information 813 and the response information 814 in FIG. 8, respectively, and speech recognition information 914 and response information 915 are acquired thereafter and added to the speech recognition history list. Accordingly, the speech recognition information 912 and the response information 913 may be scrolled upwards and/or downwards and may be displayed. The speech recognition information 914 and response information 915 may be added to the speech recognition history list by selecting the speech recognition information 811 of FIG. 8 (which corresponds to the speech recognition information 914 of FIG. 9).

Updated response information 915 corresponding to the selected speech recognition information 811 of FIG. 8 may be added to the speech recognition history list and displayed in the first window region 910 of FIG. 9. In addition to the updated response information 915, the selected speech recognition information 914 may be added to the speech recognition history list and displayed in the first window region 910. Alternatively, only the updated response information 915 not including the selected information may be added to the speech recognition history list and displayed in the first window region 910.

In addition, the user interface may be displayed in the second window region 930. Alternatively, only the user interface may be displayed in the second window region 930 without displaying the response information 915 that is updated by selecting the speech recognition information 811 of FIG. 8.

The user interface corresponding to the updated response information 915 may also include information that is updated by selecting the speech recognition information 811 of FIG. 8 in addition to the updated response information 915. In the second window region 930, information including the user interface may be updated based on a point in time at which the speech recognition information 811 of FIG. 8 was selected and may be displayed in the second window region 930.

In these examples, the generation of time points of the user interface of FIG. 7 and the user interface of FIG. 9 differ from each other. As a result, the user interface of FIG. 7 and the user interface of FIG. 9 may include different information, i.e., different room temperature information.

The second window regions 920 and 930 in which user interface is displayed are plural in number as shown in the example of FIG. 9. Accordingly, the plurality of second window regions 920 and 930 may be displayed by overlapping each other.

Referring to FIG. 9, the second window region 930 including the user interface corresponding to the updated response information 915 is displayed on the second window region 920, by overlapping the second window region 930 with the second window region 920.

It should be appreciated that each of the first and second window regions 910, 920, and 930 may be moved and/or adjusted in a size thereof, for example, in response to a user input.

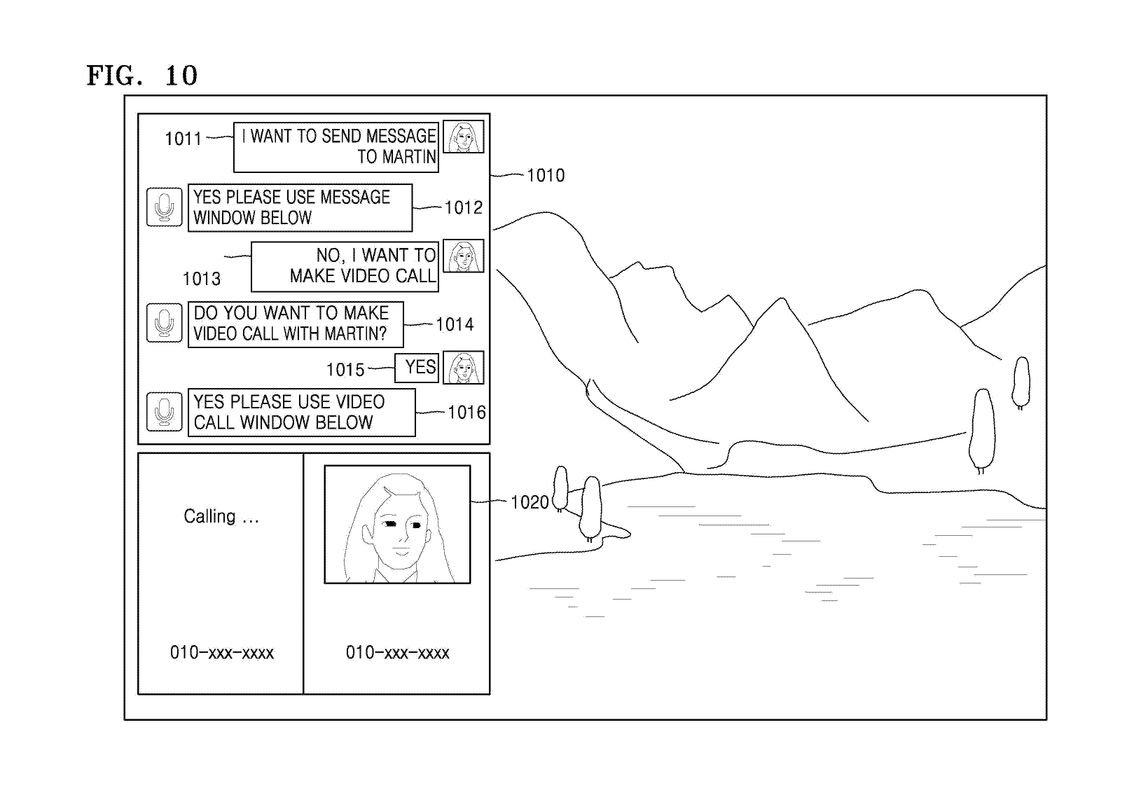

FIG. 10 illustrates an example of displaying speech recognition information based on previously acquired speech recognition information, according to an exemplary embodiment.

Referring to FIG. 10, a speech recognition history list and a user interface are displayed in a first window region 1010 and a second window region 1020, respectively.

For example, the terminal apparatus 100 may generate response information 1014 using speech recognition information 1011 and 1013 included in the speech recognition history list. That is, the terminal apparatus 100 may generate and display the response information 1014 in consideration of the speech recognition information 1011 which was previously recognized, and/or the speech recognition information 1013 which is currently recognized.

In this example, information about the other party with which to make a video call with is not included in the speech recognition information 1013, but the terminal apparatus 100 may determine that the other party is “Martin” and generate the response information 1014. Thereafter, the terminal apparatus 100 may generate and display response information 1016 and a user interface depending on a response 1015 of the user, which indicates whether the other party for the video call is “Martin”.

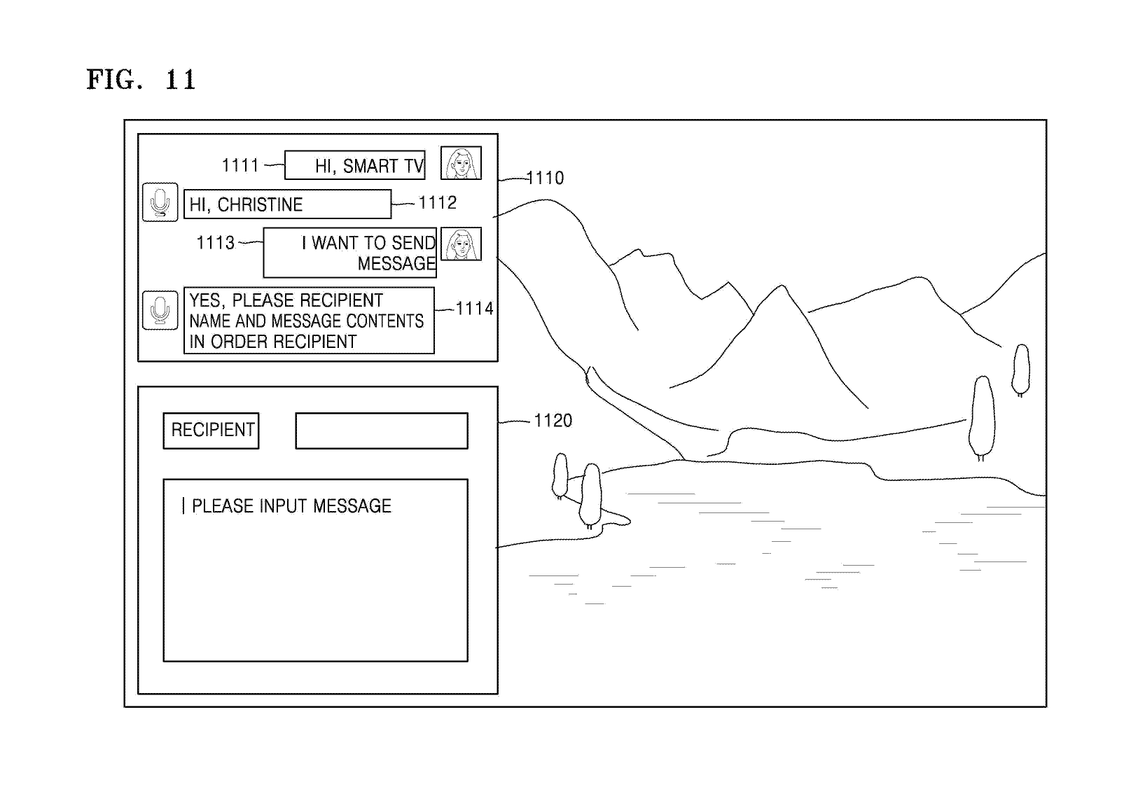

FIG. 11 illustrates an example of displaying speech recognition information including a user interface for performing an operation, according to an exemplary embodiment.

Referring to FIG. 11, a speech recognition history list and a user interface are displayed in a first window region 1110 and a second window region 1120, respectively.

In this example, the terminal apparatus 100 may display response information 1114, which includes information for inducing a speech input of the user, in response to speech recognition information 1113 of the user requesting to send a message.

The terminal apparatus 100 may determine whether information is necessary or is missing for processing the message transmission request, in response to the speech recognition information 1113 including the message transmission request, and may generate and display the response information 1114 according to a result of the determination. If it is determined that a message reception target and message contents for processing the message transmission request are missing, the terminal apparatus 100 may generate and display the response information 1114 including a request for the missing information.

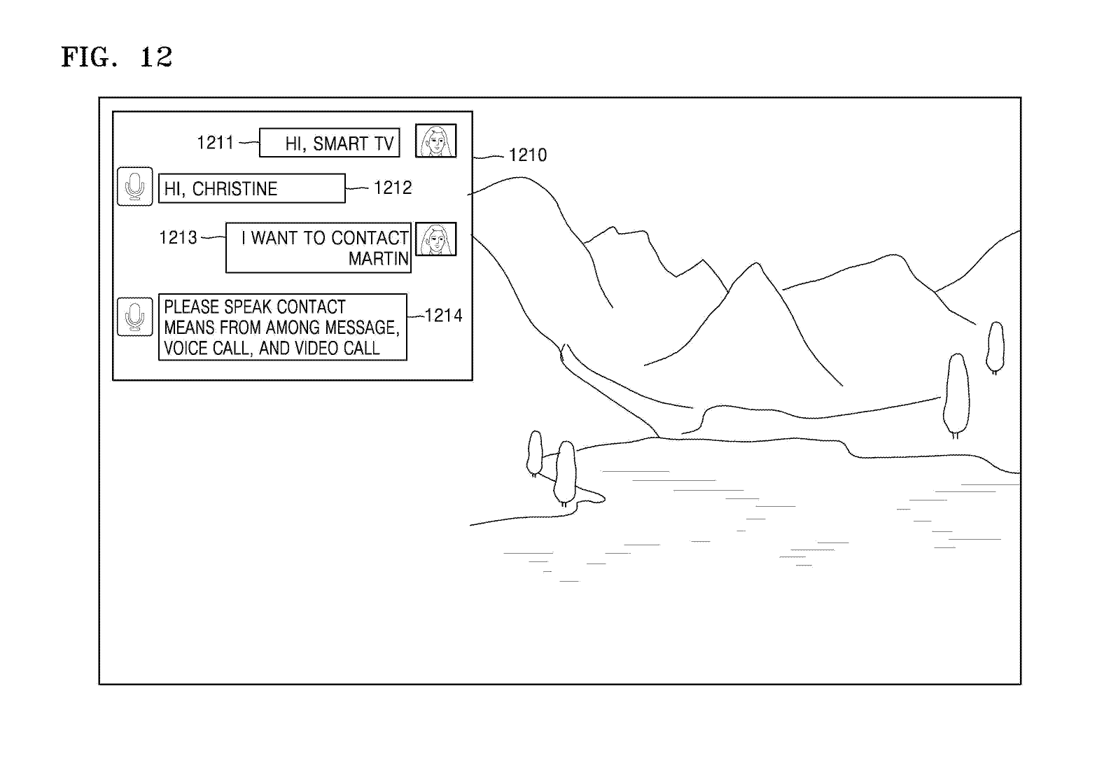

FIG. 12 illustrates an example of displaying speech recognition information including suggested words, according to an exemplary embodiment.

Referring to FIG. 12, a speech recognition history list is displayed in a first window region 1210.

The terminal apparatus 100 may display response information 1214 including suggested words for inducing a speech input of the user, in response to speech recognition information 1213.

In this example, the speech recognition information 1213 recognized from the user only includes the other party to be contacted, but a contact means is not included. Accordingly, the terminal apparatus 100 may display the response information 1214 including suggested words for inducing a speech input of the user in order to acquire information on the contact means. In this example, the terminal apparatus asks the user a question as to which contact means the user would like to use to contact the other party.

According to various exemplary embodiments, when a terminal apparatus is controlled by speech recognition, the terminal apparatus may display a speech recognition history list to enable a user to easily check a speech recognition history.

In addition, because the terminal apparatus may be controlled by an operation of selecting a piece of information from the displayed speech recognition history list, an operation performed according to speech recognition may be easily repeated by not only speech recognition but also another input means such as a keyboard, touch screen, motion input, and the like. Accordingly, a user may interact with a speech recognition history list that is displayed by a terminal apparatus thereby improving user convenience. For example, the user may perform an interactive operation with the speech recognition history by selecting one previously recorded speech recognition or response information.

According to various exemplary embodiments, an apparatus may output or display an interactive speech recognition history list. The list may include one or more items of speech and responses. For example, the speech may correspond to speech of a user that is recognized and the responses may correspond to information generated by the apparatus in response to recognized user speech. The items, or instances, may be selected by a user. In response to receiving the selection, the apparatus may perform an operation based on the item selected from the interactive speech recognition history list. For example, the apparatus may launch another window separate from the interactive speech recognition history list enabling the user to input additional data.

The methods according to exemplary embodiments may also be embodied as computer (including all devices having an information processing function)-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices.

In addition, other exemplary embodiments may also be implemented through computer-readable code/instructions in/on a medium, e.g., a computer-readable medium, to control at least one processing element to implement any above described embodiment. The medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be a defined and measurable structure including or carrying a signal or information, such as a device carrying a bitstream according to one or more embodiments of the present invention. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described herein should be considered in a descriptive sense only and not for purposes of limitation. Descriptions of features and/or aspects within each exemplary embodiment should typically be considered as available for other similar features or aspects in other exemplary embodiments.

While one or more exemplary embodiments of the present invention have been described with reference to the figures, it will be understood by those of ordinary skill in the art that various changes in form and details may be made therein without departing from the spirit and scope of the present invention as defined by the following claims.

What is claimed is:

1. A method of displaying speech recognition information, the method comprising:
acquiring at least one of speech recognition information based on speech recognized by performing speech recognition, and response information indicating a processing result of the speech recognition information;
displaying a speech recognition history list including the acquired information, in a first window region;
selecting at least one piece of the acquired information included in the speech recognition history list; and
updating response information corresponding to the selected at least one piece of acquired information.

2. The method of claim 1, wherein the updating the response information comprises updating the response information based on a point in time at which the at least one piece of information is selected.

3. The method of claim 1, wherein the response information comprises suggested words for inducing a speech input of a user.

4. The method of claim 1, wherein the selecting comprises selecting the at least one piece of information in response to a user input received by at least one of a motion input method, a touch input method, and a key input method.

5. The method of claim 1, wherein, in response to the speech recognition information comprising information about a question or request of the user, the response information corresponding to the speech recognition information comprises at least one of information indicating whether the question or request of the user is able to be processed, information about a suggestion for the question or request of the user, and information about a processing result of the question or request of the user.

6. The method of claim 1, further comprising:
displaying a user interface for performing an operation corresponding to the response information, in a second window region.

7. A terminal apparatus comprising:
a controller configured to acquire at least one of speech recognition information based on speech recognized by performing speech recognition, and response information indicating a processing result of the speech recognition information, to select at least one piece of the acquired information, and to update response information corresponding to the selected acquired information; and
a display configured to display a speech recognition history list comprising the acquired information and the updated information, in a first window region.

8. The terminal apparatus of claim 7, wherein the controller is further configured to update the response information corresponding to the selected at least one piece of information based on a point in time at which the at least one piece of information is selected.

9. The terminal apparatus of claim 7, wherein the display is further configured to display response information comprising suggested words for inducing a speech input of a user.

10. The terminal apparatus of claim 7, wherein the controller is further configured to select the at least one piece of information, in response to a user input received by at least one of a motion input method, a touch input method, and a key input method.

11. The terminal apparatus of claim 7, wherein, in response to the speech recognition information comprising information about a question or request of the user, the response information corresponding to the speech recognition information comprises at least one of information indicating whether the question or request of the user is able to be processed, information about a suggestion for the question or request of the user, and information about a processing result of the question or request of the user.

12. The terminal apparatus of claim 7, wherein the display is further configured to display a user interface for performing an operation corresponding to the response information, in a second window region.

13. A non-transitory computer-readable medium having recorded thereon a computer program that is executable by a computer to perform the method of claim 1.

14. A speech recognition apparatus comprising:
a controller configured to generate an interactive speech recognition list comprising a list of items corresponding to recognized speech and response information generated in response to the recognized speech; and
an input unit configured to receive an input for selecting at least one item from the interactive speech recognition list,
wherein the controller is further configured to perform an interactive operation based on the item selected from the interactive speech recognition list.

15. The speech recognition apparatus of claim 14, wherein the controller is configured to output the interactive speech recognition list in a first window, and, in response to performing the interactive operation based on the item selected from the interactive speech recognition list, to output a user interface (UI) in a second window.

16. The speech recognition apparatus of claim 15, wherein the controller is configured to output a plurality of UIs in response to a plurality of items being selected from the interactive speech recognition list.

17. The speech recognition apparatus of claim 14, wherein the interactive speech recognition list comprises a list of user speech and response information listed in an order based on a point in time at which they are generated.

18. The speech recognition apparatus of claim 14, further comprising a display configured to display the interactive speech recognition list generated by the controller.

19. The speech recognition apparatus of claim 14, wherein the input unit comprises a microphone that is configured to receive a voice command for selecting at least one item from the interactive speech recognition list.

20. The speech recognition apparatus of claim 14, wherein the input unit comprises at least one of a touch panel and a camera that is configured to receive at least one of a touch input and a motion input, respectively, for selecting at least one an item from the interactive speech recognition list.
